(19) United States
(12) Patent Application Publication
(10) Pub. No.: US 2025/0371975 A1
(43) Pub. Date: Dec. 4, 2025

(54) System and Method for Detecting Lost Goods

(71) Applicant: Daimler Truck AG, Leinfelden-Echterdingen (DE)

(72) Inventors: Ralf OBERFELL, Stuttgart (DE); Wilhelmus KOK, Weinstadt (DE); Christian BOOTZ, Boeblingen (DE)

(21) Appl. No.: 18/877,065

(22) PCT Filed: Jun. 20, 2023
(86) PCT No.: PCT/EP2023/066522

§ 371 Date: Dec. 19, 2024

(30) Foreign Application Priority Data
Jul. 1, 2022 (DE) 10 2022 116 543.4

(51) Int. Cl. G08G 1/07; G01G 19/08; G06Q 10/083; G06Q 10/087

(52) U.S. Cl. CPC G08G 1/07; G01G 19/08; G06Q 10/08355; G06Q 10/08778

(57) ABSTRACT

A method for detecting lost goods transported by a vehicle. A distance travelled by the vehicle is divided into sections which are seamlessly connected to each other at respective route transition points. At each route transition point a control unit is activated which determines a vehicle weight and separately a weight of operating materials used by the vehicle. A difference is formed from a vehicle weight of a preceding route transition point, a vehicle weight of a current route transition point, and the weight of the operating materials used by the vehicle. A loss of cargo is recognized and an associated section is identified when the difference is greater than a predetermined threshold.

### BACKGROUND AND SUMMARY OF THE INVENTION

The invention relates to a method for detecting lost goods and to a system for detecting lost goods.

Detecting lost cargo is a significant challenge, in particular for highly automated motor vehicles. It is difficult for the environment sensor system (for example radar, camera, lidar, ultrasound, etc.) of the motor vehicle to detect lost objects due to their small size and to distinguish them from the surroundings.

DE 10 2021 000 241 A1 describes a method for detecting a loss of cargo of a vehicle, wherein a cargo loss is determined by monitoring a load status of the vehicle and additionally the cargo loss is checked for plausibility by evaluating at least one sensor signal of at least one sensor monitoring a rear area of the vehicle. The load status of the vehicle is monitored by evaluating a spring-loaded state of a suspension of the vehicle by means of at least one spring travel sensor and a height position of the lost load is taken into account to check the plausibility of a lost load.

The invention is based on the object of specifying a novel method and a novel system for detecting lost goods, transported by means of a vehicle.

With a method according to the invention for detecting lost goods, transported by means of a vehicle, the load status of the vehicle is monitored, wherein a distance travelled by the vehicle is divided into several sections which are seamlessly connected to each other at respective route transition points, wherein at each route transition point a control unit is activated which determines a vehicle weight and separately the weight of the operating materials used by the vehicle, wherein a difference is formed from the vehicle weight of the preceding route transition point, the vehicle weight of the current route transition point and the weight of the used operating materials, wherein a loss of cargo is recognized and the associated section is identified if the difference is greater than a predetermined threshold.

The solution according to the invention enables an increase in road safety by determining a lost load.

Exemplary embodiments of the invention are explained in more detail in the following using the drawings.

### BRIEF DESCRIPTION OF THE DRAWINGS

FIG. 1 shows a schematic view to illustrate the method for finding goods transported by means of vehicles; and

FIG. 2 shows a schematic view to illustrate an algorithm which is carried out in a control unit.

### DETAILED DESCRIPTION OF THE DRAWINGS

Parts corresponding to each other are provided with the same reference signs in all the figures.

The present invention relates to a system and to a method for finding goods transported by means of vehicles which are lost on the journey.

In order to be able to determine the loss even of small goods, it is proposed according to the invention that the distance travelled is categorized into several route sections which are seamlessly connected to each other, wherein at each route transition point a control unit is activated, which initiates weighing the vehicle weight and a separate weighing the weight of the operating materials, after which the detected weight data are subtracted from each other in a computer, after which the subtracted results of consecutive transition points are compared with each other and, if a predetermined threshold value resulting from this difference is exceeded, a loss of cargo is recognized and the associated route section is identified.

In one embodiment, the categorization into route sections is performed manually by a driver or a fleet manager.

In one embodiment, the categorization into route sections is performed by a backend equipped with a corresponding logistics program, for example a cloud, or by a frontend, for example an on-board computer.

In one embodiment, the backend or the frontend communicates with the control unit to perform the weighing process.

In one embodiment, the categorization into route sections takes place depending on a topography, a route and/or a current traffic situation.

In one embodiment, the vehicle weight is measured in respective external stations.

In one embodiment, the determination of the vehicle weight takes place by means of a vehicle-specific measurement (on-board).

In one embodiment, the results are sent to a higher-level control center.

In one embodiment, a warning is sent to the control center and/or the driver if the threshold is exceeded.

In one embodiment, measures for regulating the traffic on the respective identified route sections and for recovering the cargo are initiated by the control center.

In one embodiment, traffic lights on the route section are controlled to regulate the traffic and/or vehicles passing through the route section are warned of the danger of cargo lying around.

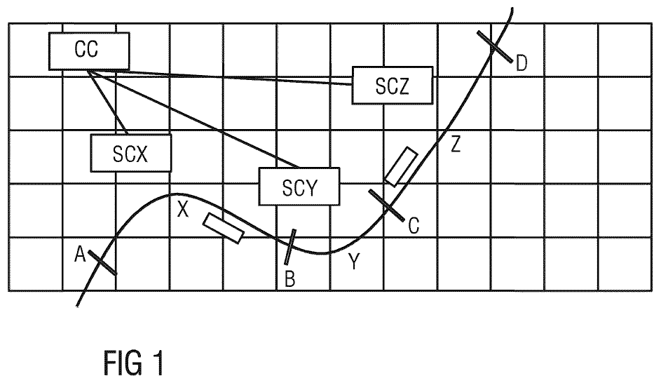

FIG. 1 is a schematic view to illustrate the method for detecting lost goods, transported by means of a vehicle.

A distance which a motor vehicle travels is divided into sections X, Y, Z. In the exemplary embodiment shown, three sections X, Y, Z are represented. In other examples, any other number of sections X, Y, Z can be provided. Each section X, Y, Z has a beginning and an end. In the present example, the beginning of the section X is a route transition point A. The end of the section X and thus the beginning of the section Y is a route transition point B. The end of the section Y and thus the beginning of the section Z is a route transition point C. The end of the section Z is a route transition point D.

For each section X, Y, Z, a control unit SCX, SCY, SCZ is provided on which an algorithm is performed, the calculation result of which is sent to a higher-level control center CC after it has been determined.

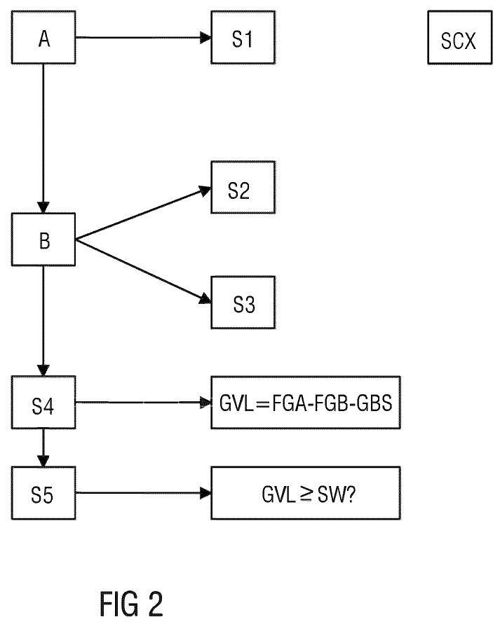

FIG. 2 shows a schematic view to illustrate the algorithm, which is carried out in the control unit SCX, for example. If a vehicle passes through the route transition point A, the vehicle weight FGA and/or the vehicle mass of the vehicle is determined at this route transition point A in step S1. This can either take place by a weighing station, i.e., offline, or online in the vehicle by software for weight determination (for example described in https://automobilkonstruktion.industrie.de/elektronik-software/software-loesung-von-fev-zur-gewichtsermittlung-bei-fahrzeugen/, accessed 25 Sep. 2020. The site is incorporated by reference in its entirety into the present application). If the vehicle passes through the route transition point B after a distance travelled, a renewed determination of the vehicle weight FGB and/or of the vehicle mass takes place by the control unit SCX in step S2. Additionally, the vehicle determines the weight GBS and/or the mass of used operating materials (e.g., fuel, wiper fluid, condensate) on the section X from route transition point A to route transition point B in step S3. Subsequently in step S4, the weight GVL of lost cargo is calculated by subtraction of both vehicle weights FGA, FGB or masses and the weight GBS and/or the mass of used operating materials.

### GVL=FGA-FGB-GBS

In step S5, the control unit SCX checks whether this weight GVL of lost cargo exceeds a certain threshold SW, for example due to tolerances, and gives a warning to the control center CC in this case. This now has the option to block the road traffic for the section concerned X, by either controlling traffic lights (which are installed at the beginning of the section X) or warning the vehicles directly of this danger.

The method is carried out for the other sections Y, Z in an analogous manner by the respectively assigned control units SCY, SCZ.

### LIST OF REFERENCE CHARACTERS:

A, B, C, D route transition point
CC control center
FGA, FGB vehicle weight
GBS weight of used operating materials
GVL weight of lost goods, difference
SCX, SCY, SCZ control unit
SW threshold
S1, S2, S3, S4, S5 step
X, Y, Z section

1.-9. (canceled)

10. A method for detecting lost goods transported by a vehicle, comprising the steps of:
a distance travelled by the vehicle is divided into sections (X, Y, Z) which are seamlessly connected to each other at respective route transition points (A, B, C, D);
wherein at each route transition point (A, B, C, D) a control unit (SCX, SCY, SCZ) is activated which determines a vehicle weight (FGA, FGB) and separately a weight of operating materials (GBS) used by the vehicle;
wherein a difference (GVL) is formed from a vehicle weight (FGA) of a preceding route transition point (A, B, C, D), a vehicle weight (FGB) of a current route transition point (A, B, C, D), and the weight of the operating materials (GBS) used by the vehicle; and
wherein a loss of cargo is recognized and an associated section (X, Y, Z) is identified when the difference (GVL) is greater than a predetermined threshold (SW).

11. The method according to claim 10, wherein a classification into the sections (X, Y, Z) is performed manually by a driver or a fleet manager or by a backend equipped with a logistics program or by a frontend.

12. The method according to claim 11, wherein the backend or the frontend communicates with the control unit (SCX, SCY, SCZ) to determine the respective weights (FGA, FGB, GBS).

13. The method according to claim 10, wherein a classification into the sections (X, Y, Z) takes place depending on a topography, a route, and/or a current traffic situation.

14. The method according to claim 10, wherein the respective vehicle weights (FGA, FGB) are determined in respective external stations or by a vehicle-specific measurement.

15. The method according to claim 10, wherein the loss of cargo and the associated section (X, Y, Z) are reported to a higher-level control center (CC) and/or to a driver of the vehicle.

16. The method according to claim 15, wherein measures for regulating traffic on the identified associated section (X, Y, Z) and for recovering the cargo are initiated by the higher-level control center (CC).

17. The method according to claim 16, wherein traffic lights on the identified associated section (X, Y, Z) are controlled to regulate the traffic and/or vehicles passing through the identified associated section (X, Y, Z) are warned of a danger of the cargo.

18. A system for detecting lost goods transported by a vehicle, wherein the system is configured to perform the method according to claim 10.
